(19) United States
(12) Patent Application Publication
(10) Pub. No.: US 2018/0195864 A1
(43) Pub. Date: Jul. 12, 2018

(54) USE OF GPS SIGNALS FROM MULTIPLE VEHICLES FOR ROBUST VEHICLE TRACKING

(71) Applicant: Conduent Business Services, LLC, Dallas, TX (US)

(72) Inventors: Abhishek Sengupta, Kolkata (IN); Narayanan Unny Edakunni, Bangalore (IN)

(73) Assignee: Conduent Business Services, LLC.

(21) Appl. No.: 15/443,295

(22) Filed: Feb. 27, 2017

(30) Foreign Application Priority Data
Jan. 12, 2017 (IN) 201721001309

(51) Int. Cl. G01C 21/00; G08G 1/133

(52) U.S. Cl. CPC G01C 21/00; G08G 1/133

(57) ABSTRACT

Methods and systems for tracking a target vehicle. GPS data can be obtained from multiple vehicles in the vicinity of a target vehicle. Such GPS data can include GPS signals associated with the multiple vehicles and GPS signals associated with the target vehicle. The GPS signals associated with the multiple vehicles can be fused, and a prediction made about the travel time of the target vehicle based on the GPS signals associated with multiple vehicles and the GPS signals associated with the target vehicle. The GPS data provides a redundancy that increases the accuracy and robustness of the prediction.

### CROSS-REFERENCE AND PRIORITY TO PATENT APPLICATION

This patent application claims priority to Indian Provisional Patent Application. No. 201721001309 filed in India on Jan. 12, 2017. India is deemed a foreign country, which affords privileges in the case of applications filed in the United States similar to those afforded under 35 U.S.C. § 119. This patent application therefore claims priority to and the benefit under 35 U.S.C. § 119 to the aforementioned Indian Provisional Patent Application No. 201721001309 filed on Jan. 12, 2017.

### TECHNICAL FIELD

Embodiments are generally related to the field of location-based vehicle tracking. Embodiments also relate to GPS devices, methods, and systems. Embodiments additionally relate to methods and systems for obtaining GPS data and predicting a vehicle's travel time.

### BACKGROUND

GPS data obtained from a vehicle can be used to track the vehicle and to predict the travel time required for the vehicle to reach its destination. However, it is difficult to provide reliable travel time predictions if the GPS is lost or if the user is not willing to share the GPS location of the vehicle. A need exists for an approach that can handle these cases using GPS data from multiple vehicles in the vicinity of the vehicle to be tracked.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide methods and systems for tracking a target vehicle using GPS data collected from multiple vehicles in the vicinity of the target vehicle.

It is another aspect of the disclosed embodiments to provide methods and systems for developing a model of travel time and using such a model to predict the travel time of a target vehicle.

It is yet another aspect of the disclosed embodiments to provide methods and systems for using GPS traces from multiple vehicles to provide travel time predictions for a single vehicle.

It is still another aspect of the disclosed embodiments to provide methods and systems for providing a model of travel time that a target vehicle can use to predict its travel time.

The aforementioned aspects and other objectives and advantages can now be achieved as described herein. Methods and systems for tracking a target vehicle are disclosed. GPS data can be obtained from multiple vehicles in the vicinity of a target vehicle. Such GPS data can include GPS signals associated with the multiple vehicles and GPS signals associated with the target vehicle. The GPS signals associated with the multiple vehicles can be fused, and a prediction made about the travel time of the target vehicle based on the GPS signals associated with multiple vehicles and the GPS signals associated with the target vehicle. The GPS data can thus provide a redundancy that increases the accuracy and robustness of the prediction.

The disclosed embodiments further allow for combining GPS locations from multiple reporting vehicles to provide more accurate and robust predictions for the location of individual vehicles and build models of travel to provide accurate predictions for travel times.

The disclosed embodiments can also provide estimates of positions and travel times for vehicles if a GPS signal is not immediately available, for example, due to a GPS outage or when a users device (e.g., GPS device, smartphone, etc.) is set to a privacy mode (e.g., a user chooses not to share his or her exact location).

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a system that utilizes GPS (Global Positioning Satellite) signals from multiple vehicles for robust vehicle tracking of a target vehicle, in accordance with an example embodiment;

FIG. 2 illustrates a flow chart of operations depicting logical operational steps of a method for using GPS signals from multiple vehicles for tracking a target vehicle, in accordance with an example embodiment;

FIG. 3 illustrates a flow chart of operations depicting logical operational steps of a method for utilizing a model of travel to predict the travel time of a target vehicle, in accordance with an example embodiment;

FIG. 4 illustrates a schematic view of a computer system, in accordance with an embodiment; and

FIG. 5 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description should therefore not be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation.”

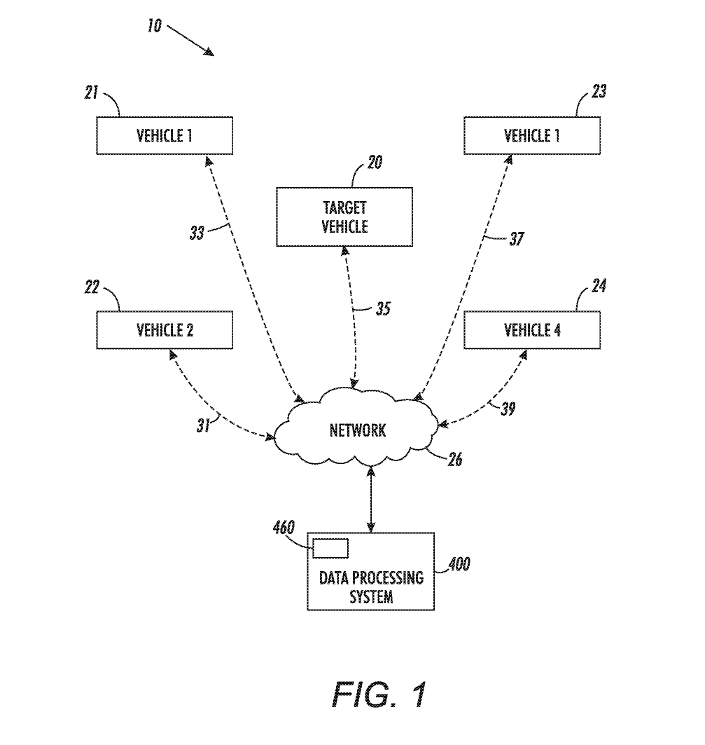

FIG. 1 illustrates a block diagram of a system 10 that utilizes GPS (Global Positioning Satellite) signals from multiple vehicles 21, 22, 23, 24 for robust vehicle tracking of a target vehicle 20, in accordance with an example embodiment. The system 10 shown in FIG. 1 utilizes GPS data such as GPS traces/signals respectively obtained from and transmitted by vehicles 22, 21, 20, 23, and 24 through a network (e.g., a wireless network) to a data-processing system 400 (e.g., a server) in communication with and/or operably coupled to the network 26. Each of the vehicles 22, 21, 20, 23, and 24 can be equipped with a GPS device that determines a location based on GPS signals. Note that the dashed lines 31, 33, 35, 37, and 39 shown in FIG. 1 represent the communication (e.g., the transmission and/or receipt) of data between the network 26 and respective vehicles 22, 21, 20, 23, and 24.

The data processing system 400 may further include a filter 460 (e.g., a Kalman filter), which is discussed in further detail herein. The filter 460 may be provided ire the form of a module such as module 452 shown in FIG. 5, which is discussed in greater detail herein.

The GPS device (in some instances referred to simply as a “GPS”) can be integrated with each vehicle 22, 21, 20, 23, and/or 24, or may be integrated with a mobile computing device (e.g., a smartphone or tablet computing device) located in one or more of the vehicles 22, 21, 20, 23, and/or 24. In other words, a user's mobile computing device may be situated in one of the vehicles 22, 21, 20, 23, and 24 and a GPS trace/signal from such a mobile computing device may be utilized in accordance with the disclosed embodiments to facilitate a prediction of the travel time of one or more of the vehicles 22, 21, 20, 23, and 24 and in particular the target vehicle 20.

As indicated previously, it is difficult to provide reliable travel time predictions if the GPS is lost or if the GPS user is not willing to share the GPS location of the vehicle (e.g., the target vehicle). Various embodiments are thus described herein that address these types of situations using the GPS data from, for example, multiple vehicles 22, 21, 23, and 24 in the vicinity of the target vehicle 20.

The system 10 is configured to allow the target vehicle 20 to be provided with predictions about its travel time using GPS data obtained from vehicles 21, 22, 23, and 24 in the vicinity of the target vehicle 20. The GPS data obtained from 21, 22, 23, 24 and/or 20 can be fused to provide reasonable predictions with respect to the target vehicle 20. In addition, when the target vehicle 20 is unwilling to share its GPS due to concerns of privacy, the GPS data from the vehicles 21, 22, 23, 24 in the vicinity of the target vehicle 20 can be used to provide a model to the target vehicle 20, which can then compute its own prediction for the travel time.

The network 26 shown in FIG. 1 can couple devices (e.g., smartphones, tablet computing devices, GPS devices) so that communications may be exchanged, such as between a server and a client device or other types of devices, including between wireless devices coupled via a wireless network, for example. The network 26 may include mass storage, such as network-attached storage (NAS), a storage area network (SAN), or other forms of computer or machine-readable media, for example. The network 26 may include the Internet, one or more Local Area Networks (LANs), one or more Wide Area Networks (WANs), cellular networks, wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDN), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example, or other communications means (e.g., wireless).

Assuming network 26 is a wireless network, such a wireless network may couple client devices with the network 26. That is, such a wireless network may employ stand-alone ad-hoc networks, mesh networks, wireless LAN (WLAN) networks, cellular networks, or the like. Such a wireless network can further include a system of terminals, gateways, routers, or the like coupled by wireless radio links or the like, which may move freely, randomly, or organize themselves arbitrarily, such that network topology may change, at times even rapidly. Such a wireless network may further employ a plurality of network access technologies including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, the network 26 may be configured to enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Note that signal packets communicated via network 26, such as a network of participating digital communication networks, may be compatible with or compliant with one or more protocols. Signaling, formats or protocols employed may include, for example, TCP/IP, UDP, DECnet, NetBEUI, IPX, AppleTalk, or the like. Versions of the Internet Protocol (IP) may include IPv4 or IPv6.

The Internet refers to a decentralized global network of networks. The Internet includes Local Area Networks (LANs), Wide Area Networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc., that may route the signal packet in accordance with a target address and availability of a network path to the target address.

System 10 uses the location data from vehicles 20, 21, 22, 23, and/or 24 to build one or more models of travel to provide accurate predictions for travel times. Embodiments can be implemented with a number of settings. For example, a setting can be provided that uses GPS traces from the multiple vehicles 21, 22, 23, and 24 around the target vehicle 20 to obtain a reliable idea of the travel speeds prevailing in that area. Fusing the signals allows us to provide robust tracking for the target vehicle 20 and travel time estimates for the target vehicle 20. Another setting can involve GPS outage. For example when there is an outage in the GPS signal of the target vehicle 20, the additional GPS signals (e.g., from one or more of the vehicles 21, 22, 23, 24) can help to provide travel time estimates for the target vehicle 20.

In another setting, the same application can be used when the users value privacy and are not prepared (or are unable) to send their locations but can give an approximate position of their vehicle. Using this approximate position, the location data of other vehicles can be used to provide predictions for the target vehicle 20. For instance, if the target vehicle 20 is a private car and there are other vehicles such as buses driving in the same region, then the disclosed approach can use the location data obtained from buses to learn the travel speeds in the region and use this information to predict the travel times of the target vehicle. The target vehicle can thus receive predictions even without sharing its own location.

There has been previous research into fusing multiple sensors to make the tracking more robust, but the sensors used in these situations are fitted into the same vehicle and are hence expensive for an individual. In the disclosed embodiments, the sensors (e.g., GPS devices) are distributed across different vehicles (e.g., vehicles 21, 22, 23, and/or 24) thereby increasing redundancy resulting in a robust tracking mechanism. As will be discussed shortly, a filter such as, for example, a Kalman Filter (KF) (e.g., such as the filter 460 shown in FIG. 1) can be configured to make use of multiple observations of locations to build a model of the environment. This model can then be used to predict the travel time of an individual vehicle such as target vehicle 20 (or another vehicle) in the presence or absence of vehicles in its vicinity.

A Kalman Filter (KF) is a linear dynamical system (LDS) that models a sequence of measurements and an underlying sequence of states that represents the system dynamics with the assumption that both the state-evolution and measurement sequences are corrupted by noise. Such models attempt to capture the dynamics of the system states that govern that temporal evolution of the measurements unlike static models such as support vector machines and random forests wherein the temporal dependencies between successive measurements in time are usually not modeled. The disclosed embodiments consider the GPS traces of the vehicles to be the observations (possibly corrupted by noise). The hidden state variables can be considered to be a representative of the underlying traffic conditions, which play an important role in governing a vehicle's location.

In accordance with an example embodiment, a Kalman Fitter can utilize multiple observations. Suppose there are M vehicles moving at close proximity to each other during the complete duration of their journey, and there are N such instances of this behavior. Let yₜ be a vector denoting the latitude and longitude of a vehicle at time t. A model can thus be formulated as follows as shown at equations (3.01) below:

zₜ=Azᵢ₋₁+ϵₜ

y_{m,t}=Cₘzₜ+δ_{m,t m=}1,2, . . . , M (3.0.1)

The formula zₜ ∈ [symbol] ^{k} denotes the hidden or stat-space variables. The formula y_{m,t} ∈ [symbol] ^{p} denotes the observation variables (latitude and longitude) for vehicle m at time t. The parameter A_{k×k} denotes the underlying state transition matrix. The parameter Cₘ_{_{y,k}} denotes the observation matrix that maps the state-space variables zₜ into the observed variables y_{m,i}. ϵₜ and δ_{m,t} are the noise corrupting the state-space and observation variables, respectively.

It can be assumed that both the process noise and observation noise are zero-mean Gaussian with an unknown co-variance, that is,

ϵₜ˜ [symbol] (0, Q), δ_{m,t}˜ [symbol] (0, Rₘ)

Thus, all the vehicles share the same hidden states (which can be representative of the current traffic condition), and the observations for each vehicle vary due to the matrix Cₘ.

For the problem at hand, the noise statistics as well as the system dynamics are unknown. Thus, we include both the noise statistics and system dynamics in our parameter set and attempt to learn them through a maximum likelihood approach using the data. Thus, the complete set of parameters in our case is θ=(A, Cₘ, Q, Rₘ).

In this next section, it is demonstrated how to estimate all parameters of our model, θ, using Expectation Maximization (EM), given N×M sequential observations

$${y}_{m i} = \{ {y}_{{m i}_{1}} , . . . , {y}_{{m i}_{{I}_{mi}}} \}$$

i=1 . . . N, m=1 . . . M each of different lengths Tₘᵢ.

The general EM framework is as follows. Given data Y, unobserved latent variables Z, and unknown parameters θ want to obtain the maximum likelihood of θ, where the likelihood is given by

$$L ( θ ; X ) = p ( X \vert θ ) = {\sum }_{z} p ( X , Z \vert θ ) .$$

In many cases (including ours), this quantity is intractable and so, EM is used to iteratively estimate the, parameters using the following two steps, with suitable initial values θ^{(o)} and a predetermined termination criterion.

E Step: Calculate the expected value of the likelihood function with respect to the conditional distribution of Z|X with the current estimate of Q(θ|θ^{(t)})=E_{Z|X,θ}_{^{(t)}}[log L(θ,X,Z)].

M Step: Find current parameter estimates that maximizes this quantity: θ^{(t+1)}=arg max_{θ}Q(θ|θ^{(t)}).

In the following model we elaborate on each of the steps for estimating parameters of the disclosed model. Assuming the hidden states to be known, the likelihood of the data (for a single observation sequence for the m^{th} vehicle) is given by the following:

$$L ( θ \vert D ) = p ( {z}_{1} ) {{Π}_{t = 2}}^{T} p ( {z}_{t} \vert {z}_{t - 1} ) {{Π}_{t = 1}}^{T} p ( {y}_{mt} \vert {z}_{t} ) \qquad ( 4.0 .1 )$$

This stems from the first-order Markovian assumption made on the state-variables. That is, p(zₜ|zₜ₋₁,zₜ₋₂, . . . z_{t-N})=p(zₜ|zₜ₋₁). In equation (4.0.1) above, p(z₁)˜N(μ₁,Σ₁); p(zₜ|zₜ₋₁)˜N(Azₜ₋₁, Q); and p(yₘₜ|zₜ)˜N(CₘZₜ,Rₘ). Thus, the log likelihood of the data is:

$$l ( θ \vert D ) = - \frac{1}{2} log \vert {\sum }_{1} \vert - \frac{1}{2} {\sum }_{t = 1}^{N} {( {z}_{1} - {μ}_{1} )}^{l} {\sum }_{1}^{- 1} ( {z}_{1} - {μ}_{1} ) - {\sum }_{t = 2}^{T} \{ \frac{1}{2} {( {z}_{t} - A {z}_{t - 1} )}^{′} {Q}^{- 1} ( {z}_{t} - A {z}_{t - 1} ) \} - \frac{1}{2} ( T - 1 ) log \vert Q \vert - {\sum }_{t = 1}^{T} \{ \frac{1}{2} {( {y}_{m t} - {C}_{m} {z}_{t} )}^{′} {R}_{m}^{- 1} ( {y}_{m t} - {C}_{m} {z}_{t} ) \} - \frac{1}{2} T log \vert {R}_{m} \vert - \frac{1}{2} T ( p + k ) log 2 Π \qquad ( 4.0 .2 )$$

For N×M observation sequences, the modified log likelihood is:

$$l ( θ \vert D ) = - \frac{1}{2} MN log \vert {\sum }_{1} \vert - \frac{1}{2} M {\sum }_{t = 1}^{N} {( {z}_{i 1} - {μ}_{1} )}^{l} {\sum }_{1}^{- 1} ( {z}_{i 1} - {μ}_{1} ) - {\sum }_{i = 1}^{N} {\sum }_{m = 1}^{M} {\sum }_{t = 2}^{{T}_{m i}} \{ \frac{1}{2} {( {z}_{i t} - A {z}_{i ( t - 1 )} )}^{′} {Q}^{- 1} ( {z}_{i t} - A {z}_{i ( t - 1 )} ) \} - \frac{1}{2} {\sum }_{t = 1}^{N} {\sum }_{m = 1}^{M} ( {T}_{mi} - 1 ) log \vert Q \vert - {\sum }_{i = 1}^{N} {\sum }_{m = 1}^{M} {\sum }_{t = 1}^{{T}_{i}} \{ \frac{1}{2} {( {y}_{m {i}_{l}} - {C}_{m} {z}_{i t} )}^{′} {R}_{m}^{- 1} ( {y}_{{m i}_{t}} - {C}_{m} {z}_{i t} ) \} - \frac{1}{2} {\sum }_{i = 1}^{N} {\sum }_{m = 1}^{M} {T}_{mi} log \vert {R}_{m} \vert - \frac{1}{2} {\sum }_{i = 1}^{N} {\sum }_{m = 1}^{M} {T}_{m i} ( p + k ) log 2 Π \qquad ( 4.0 .3 )$$

However, zᵢ's are not observed, and we use EM to estimate the parameters. We can now derive the equations needed in these two steps for our model as follows

M Steps

$$\begin{matrix}\frac{\partial l ( θ \vert D )}{\partial {C}_{m}} = - {\sum }_{m = 1}^{M} {\sum }_{i = 1}^{{T}_{m i}} {R}_{m}^{- 1} {y}_{{m i}_{t}} + {\sum }_{i = 1}^{M} {\sum }_{t = 1}^{{T}_{m i}} {R}_{m}^{- 1} {C}_{m} = 0 ⇒ {C}_{m}^{( 1 )} = ( {\sum }_{m = 1}^{M} {\sum }_{i = 1}^{{T}_{m i}} {y}_{{m i}_{t}} ) {( {\sum }_{m = 1}^{M} {\sum }_{i = 1}^{{T}_{m i}} )}^{- 1} \\ where = E ( {z}_{it} \vert 𝓎 1 \text{:} {T}_{mi} ) ; = E ( {z}_{it} {z}_{it}^{′} \vert 𝓎 1 \text{:} {T}_{mi} ) & 1. \\ \frac{\partial l ( θ \vert D )}{\partial A} = - {\sum }_{i = 1}^{N} {\sum }_{m = 1}^{M} {\sum }_{t = 2}^{{T}_{m i}} {Q}^{- 1} + {\sum }_{i = 1}^{N} {\sum }_{m = 1}^{M} {\sum }_{t = 2}^{{T}_{m i}} {Q}^{- 1} {A}_{{z}_{i}} = 0 ⇒ {A}^{( 1 )} = ( {\sum }_{i = 1}^{N} {\sum }_{m = 1}^{M} {\sum }_{t = 2}^{{T}_{m i}} ) {( {\sum }_{i = 1}^{N} {\sum }_{m = 1}^{M} {\sum }_{t = 2}^{{T}_{m i}} {z}_{i} )}^{- 1} \\ where = E ( {z}_{it} {z}_{i ( t - 1 )}^{′} \vert 𝓎 1 \text{:} {T}_{mi} ) & 2. \\ \frac{\partial l ( θ \vert D )}{\partial {μ}_{1}} = {\sum }_{1}^{- 1} ( - {μ}_{1} ) - 0 ⇒ {μ}_{1}^{( 1 )} = \frac{1}{N} {\sum }_{i = 1}^{N} & 3. \\ \frac{\partial l ( θ \vert D )}{\partial {\sum }_{1}^{- 1}} = \frac{1}{2} N {\sum }_{1} - \frac{1}{2} ( {\sum }_{i = 1}^{N} - {\sum }_{i = 1}^{N} {μ}_{1}^{{( 1 )}^{′}} - {μ}_{1}^{( 1 )} {\sum }_{i = 1}^{N} + {μ}_{1}^{( 1 )} {μ}_{1}^{{( 1 )}^{′}} ) ⇒ {\sum }_{1}^{( 1 )} = \frac{1}{N} {\sum }_{i = 1}^{N} + \frac{1}{N} \{ {\sum }_{i = 1}^{N} ( - ) {( - )}^{′} \} - \frac{1}{N} {\sum }_{i = 1}^{N} \\ where = \frac{1}{N} {\sum }_{i = 1}^{N} & 4. \\ {Q}^{( 1 )} = \frac{1}{{\sum }_{i = 1}^{N} {\sum }_{m = 1}^{M} ( {T}_{mi} - 1 )} {\sum }_{i = 1}^{N} {\sum }_{m = 1}^{M} ( {\sum }_{t = 2}^{{T}_{m i}} - {A}^{( 1 )} {\sum }_{t = 2}^{{T}_{m i}} ) & 5. \\ {R}_{m}^{( 1 )} = \frac{1}{{\sum }_{i = 1}^{N} {\sum }_{m = 1}^{M} {T}_{mi}} {\sum }_{i = 1}^{N} {\sum }_{m = 1}^{M} {\sum }_{t = 2}^{{T}_{m i}} ( {𝒴}_{{mi}_{i}} {𝒴}_{{mi}_{i}}^{′} - {C}_{m}^{( 1 )} {𝒴}_{it}^{′} ) & 6.\end{matrix}$$

E Step

These steps are obtained directly from the Kalman smoothing equations using the following relations:

\hat{z}ₜ=E(zₜ|y_{1:T})=μ_{t|T} 1.

[symbol]

=E(zₜz′ₜ|y_{1:T})=Σ_{t|T}+μ_{t|T}μ′_{t|T} 2.

[symbol]

=E(zₜz′ₜ₋₁|y_{1:T})=Cov(zₜ, zₜ₋₁|y_{1:T})+μ_{t|T}μ′_{t-1|T}

Cov(zₜ, zₜ₋₁|y_{1:T}) [symbol] Σ_{t,t-1|T}=Σ_{t|t}J′ₜ₋₁+Jₜ(Σ_{t+1,t|T}−AΣ_{t|t})J′ₜ₋₁

where, Σ_{T,T-1|T}=(I−K_{T}C)AΣ_{T-1|T-1}. 3.

It may so happen that of all the vehicles being tracked, some or all of them at some point of time start moving in a different direction and thus may no longer follow a similar trajectory as that of the vehicle of interest. In such cases, we introduce a new variable Δₘ, which denotes the distance between the vehicle of interest \tilde{m} and the others, m=1, . . . M. We learn the parameters from only those time points t for each vehicle such that Δₘᵢ_{ₜ}=∥y_{\hat{m}i}_{ₜ}−yₘᵢ_{ₜ}∥₂ is less than a predetermined threshold. For example, in some experiments, the parameter Δₘ=500 meters can be utilized.

Once the model parameters are learned, the next step is to predict the location of the vehicle of interest at a future time point. For example, let \tilde{m} be the vehicle of interest. Then, the predicted location of the vehicle h time points ahead, is given by ŷ [symbol] =E[y [symbol] [y₁: M,1:t] where the conditional expectation is based on all observations until time t from all vehicles which are at distance less than Δₘ from vehicle \tilde{m}.

Further, if we assume that we have information on all the other vehicles (except the vehicle of interest) until time t+h, then we can improve our prediction by incorporating this additional information. In this case, the prediction is given by the expectation ŷ [symbol] , which is conditioned on all vehicles until time point t+h (except \tilde{m}). For our experiments, we use this Conditional Expectation. The Expectation is computed by using the same EM Algorithm as described previously, with the parameters learnt from the training model being used as the initial estimates.

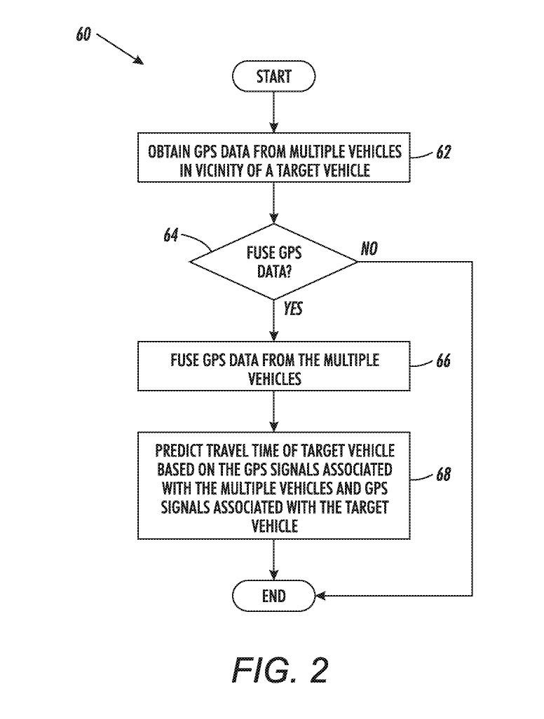

FIG. 2 illustrates a flow chart of operations depicting logical operational steps of a method 60 for using GPS signals from multiple vehicles for tracking a target vehicle, in accordance with an example embodiment. As indicated at block 62, a step or operation can be implemented for obtaining GPS data from a group of vehicles in the vicinity of the target vehicle. The GPS data can include GPS signals associated with each respective vehicle in the group of vehicles. The GPS data may also include a GPS signal associated with the target vehicle. Thereafter, as depicted at block 64, a test can be performed to determine if the GPS signals associated with the group of signals are to be fused. If not, then the process ends. If so, then as shown next at block 66, a step or operation can be implemented to fuse the GPS signals. Thereafter, as depicted at block 68, a step or operation can be implemented to predict a travel time of the target vehicle based on the GPS signals associated with the group of vehicles and (optionally) the GPS signal associated with the target vehicle. In this manner, the GPS data provides a redundancy, increases the accuracy and robustness of the prediction and hence, improves the underlying technology for tracking the target vehicle.

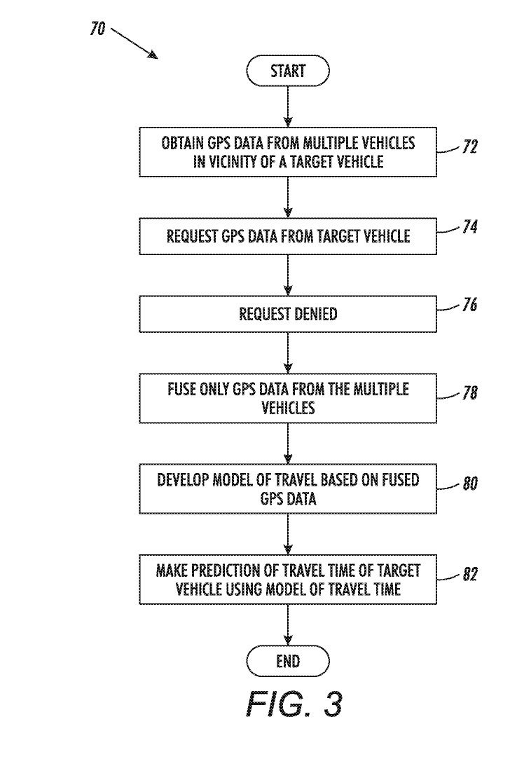

FIG. 3 illustrates a flow chart of operations depicting logical operational steps of a method 70 for utilizing a model of travel to predict the travel time of a target vehicle, in accordance with an example embodiment. As indicated at block 72, a step or operation can be implemented to obtain GPS signals from multiple vehicles in the vicinity of a target vehicle. A request can also be made, as indicated at block 74, to obtain a GPS signal from the target vehicle. Assuming the request is denied as shown at block 76, then as indicated at block 78, the GPS data from the group of vehicles is fused. This data can then be used, as depicted at block 80, to develop a model based on the fused GPS data. A prediction regarding the travel time of the target vehicle can then be made using the aforementioned model of travel time, as shown at block 82. The process can then terminate.

As can be appreciated by one skilled in the art, embodiments can be implemented in the context of a method, data processing system, or computer program product Accordingly, embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the users computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN) wireless data network e.g., Wi-Fi, Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example, a special-purpose computer, a general-purpose computer, or other programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/ad specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

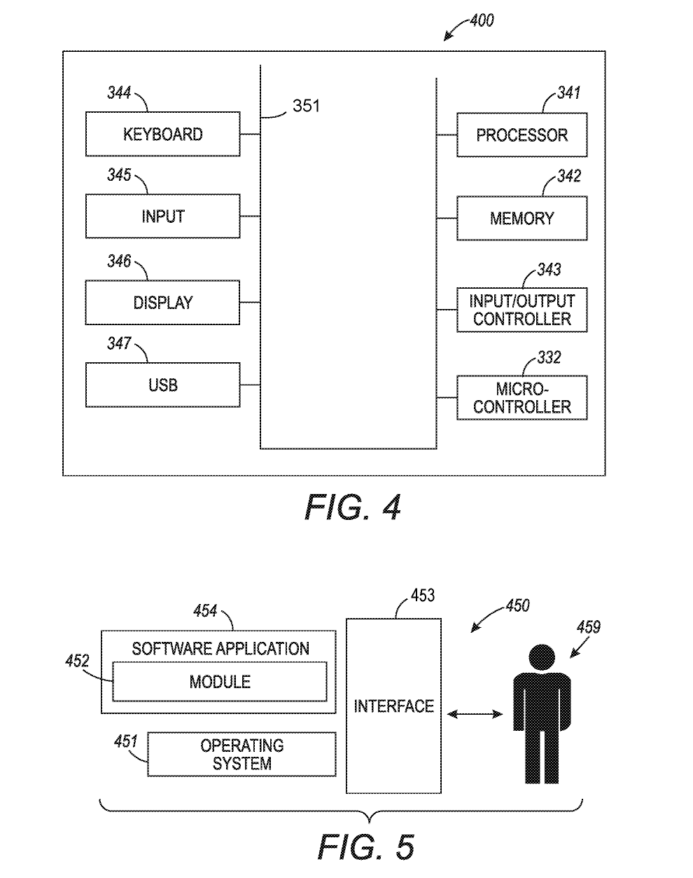

FIGS. 4-5 are shown only as exemplary diagrams of data-processing environments in which embodiments may be implemented. It should be appreciated that FIGS. 4-5 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 4, some example embodiments may be implemented in the context of a data-processing system 400 that can include, for example, one or more processors such as a processor 341 (e.g., a CPU (Central Processing Unit) and/or other microprocessor), a memory 342, an input/output controller 343, a microcontroller 332, a peripheral USB (Universal Serial Bus) connection 347, a keyboard 344 and/or another input device 345 (e.g., a pointing device, such as a mouse, track ball, pen device, etc.), and a display 346.

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server).

In some example embodiments, data-processing system 400 may be, for example, a standalone desktop computer, a laptop computer, a Smartphone, a pad computing device and so on, wherein each such device is operably connected to and/or in communication with a client-server based network or other types of networks (e.g., cellular networks, etc.).

FIG. 5 illustrates a computer software system 450 for directing the operation of the data-processing system 400 depicted in FIG. 4. Software application 454, stored for example in memory 342, generally includes a kernel or operating system 451 and a shell or interface 453. One or more application programs, such as software application 454, may be “loaded” (i.e., transferred from, for example, mass storage or another memory location into the memory 342) for execution by the data-processing system 400. The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user 459 may supply additional inputs or terminate a session. The software application 454 can include module(s) 452, which can, for example, implement instructions or operations such as those discussed herein with respect to FIGS. 1-3. Module 452 can also implement components such as the filter 460 (e.g., Kalman Filter) shown in FIG. 1.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 4-5 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

The claims, description, and drawings of this application may describe one or more of the instant technologies in operational/functional language, for example, as a set of operations to be performed by a computer. Such operational/functional description in most instances can be specifically-configured hardware (e.g., because a general purpose computer in effect becomes a special-purpose computer once it is programmed to perform particular functions pursuant to instructions from program software). Note that the data-processing system 400 discussed herein may be implemented as special-purpose computer in some example embodiments. In some example embodiments, the data-processing system 400 can be programmed to perform the aforementioned particular instructions thereby becoming in effect a special-purpose computer.

Importantly, although the operational/functional descriptions described herein are understandable by the human mind, they are not abstract ideas of the operations/functions divorced from computational implementation of those operations/function. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one skilled in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, Java, Visual Basic), etc., or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea In an example embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically, consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as, sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one skilled in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state may be used to construct a machine based on the above technical description. Charles Babbage, for example constructed the first computer out of wood and powered by cranking a handle.

Thus, far from being understood as an abstract idea, it can be recognized that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc., with natural language simply cannot be taken as an indication that such functional/operational technical descriptions are abstract ideas, or mere expressions of abstract ideas. In fact, as outlined herein, in the technological arts this is simply not true. When viewed through the tools available to those skilled in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person skilled in the art in understanding the described subject matter by providing a description that is more or less independent of any specific vendors piece(s) of hardware.

The use of functional/operational technical descriptions assists the person skilled in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person skilled in the art could encounter undue difficulty in implementing the disclosure, because such a low-level technical description would likely add complexity without a corresponding, benefit (e.g., by describing the subject matter utilizing the conventions of one or more vendor-specific pieces of hardware). Thus, the use of functional/operational technical descriptions assists those skilled in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one skilled in the art can readily understand and apply in a manner independent of a specific vendors hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or yet again alternatively, the implementer may opt for some combination of hardware, software, firmware, etc., in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted/adaptable,” “able,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and/or firmware would be well within the skill of one skilled in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Based on the foregoing, it can be appreciated that text comprehension is an important and challenging task in natural language processing, especially for the question-answering task. Traditional question answering approaches mainly use information retrieval techniques or knowledge bases to extract answers, and are not capable of understanding the meaning of text and reasoning over the available information. Deep neural networks using memory components can be used to solve this issue. The disclosed Long-Term Memory Network is based on a novel recurrent neural network, which can encode raw text information (e.g., the input sentences and questions) into vector representations, form memories, find relevant sentences to answer the questions, and finally generate multiword answers using a long short term memory network. The disclosed architecture is a weakly supervised model and can be trained end-to-end.

Benefits of the disclosed embodiments include accuracy in location and travel prediction as well as the ability to preserve privacy in a mobility context. In particular, the disclosed embodiments can provide locations and travel times for private cars using data from public vehicles, which does not raise privacy considerations. Finally, the disclosed embodiments can be used to provide micro-grained predictions, fusing data from an individual on driving style to provide more personally accurate predictions of location and travel times.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A method for tracking vehicles using GPS signals, comprising:
obtaining GPS data from a plurality of vehicles in a vicinity of a target vehicle, said GPS data including GPS signals associated with said plurality of vehicles and GPS signals associated with said target vehicle;
fusing said GPS signals associated with said plurality of vehicles; and
making a prediction about a travel time of said target vehicle based on said GPS signals associated with said plurality of vehicles and said GPS signals associated with said target vehicle, said GPS data providing a redundancy, wherein said redundancy increases an accuracy and robustness of said prediction.

2. The method of claim 1 further comprising requesting from said target vehicle sharing of said GPS signals associated with said target vehicle.

3. The method of claim 1 further comprising if said target vehicle is unwilling to share said GPS signals associated with said target vehicle due to an indication of a privacy concern, utilizing only said GPS signals associated with said plurality of said vehicles to provide a model of travel to said target vehicle that said target vehicle utilizes to make a prediction about said travel time of said target vehicle.

4. The method of claim 1 further comprising:
requesting from said target vehicle sharing of said GPS signals associated with said target vehicle; and
if said target vehicle is unwilling to share said GPS signals associated with said target vehicle due to an indication of a privacy concern, utilizing only said GPS signals associated with said plurality of said vehicles to provide a model of travel to said target vehicle that said target vehicle utilizes to make a prediction about said travel time of said target vehicle.

5. The method of claim 1 further comprising providing a filter that utilizes said GPS data including multiple observations of associations associated with said plurality of vehicles to output a model of an environment that includes said plurality of vehicles with respect to said target vehicle.

6. The method of claim 1 further comprising utilizing a model of an environment to predict said travel time of said target vehicle in said vicinity in a presences or an absence of vehicles in said vicinity, wherein said environment includes said plurality of vehicles with respect to said target vehicle.

7. The method of claim 1 further comprising:
providing a filter that utilizes said GPS data including multiple observations of associations associated with said plurality of vehicles to output a model of an environment that includes said plurality of vehicles with respect to said target vehicle; and
utilizing said model to predict said travel time of said target vehicle in said vicinity in a presences or an absence of vehicles in said vicinity.

8. The method of claim 7 wherein said filter comprises a Kalman filter.

9. A system for tracking vehicles using GPS signals, said system comprising:
at least one processor; and
a non-transitory computer-usable medium embodying computer program code, said computer-usable medium capable of communicating with said at least one processor, said computer program code comprising instructions executable by said at least one processor and configured for:
obtaining GPS data from a plurality of vehicles in a vicinity of a target vehicle, said GPS data including GPS signals associated with said plurality of vehicles and GPS signals associated with said target vehicle;
fusing said GPS signals associated with said plurality of vehicles; and
making a prediction about a travel time of said target vehicle based on said GPS signals associated with said plurality of vehicles and said GPS signals associated with said target vehicle, said GPS data providing a redundancy, wherein said redundancy increases an accuracy and robustness of said prediction.

10. The system of claim 9 wherein said instructions are further configured for requesting from said target vehicle sharing of said GPS signals associated with said target vehicle.

11. The system of claim 9 wherein said instructions are further configured for: if said target vehicle is unwilling to share said GPS signals associated with said target vehicle due to an indication of a privacy concern, utilizing only said GPS signals associated with said plurality of said vehicles to provide a model of travel to said target vehicle that said target vehicle utilizes to make a prediction about said travel time of said target vehicle.

12. The system of claim 9 wherein said instructions are further configured for:
requesting from said target vehicle sharing of said GPS signals associated with said target vehicle; and
if said target vehicle is unwilling to share said GPS signals associated with said target vehicle due to an indication of a privacy concern, utilizing only said GPS signals associated with said plurality of said vehicles to provide a model of travel to said target vehicle that said target vehicle utilizes to make a prediction about said travel time of said target vehicle.

13. The system of claim 9 further comprising a filter that utilizes said GPS data including multiple observations of associations associated with said plurality of vehicles to output a model of an environment that includes said plurality of vehicles with respect to said target vehicle.

14. The system of claim 9 wherein said instructions are further configured for utilizing a model of an environment to predict said travel time of said target vehicle in said vicinity in a presences or an absence of vehicles in said vicinity, wherein said environment includes said plurality of vehicles with respect to said target vehicle.

15. The system of claim 9 further comprising a filter that utilizes said GPS data including multiple observations of associations associated with said plurality of vehicles to output a model of an environment that includes said plurality of vehicles with respect to said target vehicle and wherein said model is utilized to predict said travel time of said target vehicle in said vicinity in a presences or an absence of vehicles in said vicinity.

16. The system of claim 15 wherein said filter comprises a Kalman filter.

17. A non-transitory processor-readable medium storing computer code representing instructions to cause a process for tracking vehicles using GPS signals, said computer code comprising code to:
obtain GPS data from a plurality of vehicles in a vicinity of a target vehicle, said GPS data including GPS signals associated with said plurality of vehicles and GPS signals associated with said target vehicle;
fuse said GPS signals associated with said plurality of vehicles; and
make a prediction about a travel time of said target vehicle based on said GPS signals associated with said plurality of vehicles and said GPS signals associated with said target vehicle, said GPS data providing a redundancy, wherein said redundancy increases an accuracy and robustness of said prediction.

18. The processor-readable medium of claim 17 wherein said code further includes code to:
request from said target vehicle sharing of said GPS signals associated with said target vehicle; and
if said target vehicle is unwilling to share said GPS signals associated with said target vehicle due to an indication of a privacy concern, utilize only said GPS signals associated with said plurality of said vehicles to provide a model of travel to said target vehicle that said target vehicle utilizes to make a prediction about said travel time of said target vehicle.

19. The processor-readable medium of claim 17 wherein said code further includes code to:
provide a filter that utilizes said GPS data including multiple observations of associations associated with said plurality of vehicles to output a model of an environment that includes said plurality of vehicles with respect to said target vehicle; and
utilize said model to predict said travel time of said target vehicle in said vicinity in a presences or an absence of vehicles in said vicinity.

20. The processor-readable medium of claim 19 wherein said filter comprises a Kalman filter.
